(19) United States
(12) Patent Application Publication
(10) Pub. No.: US 2009/0013361 A1
(43) Pub. Date: Jan. 8, 2009

(54) METHOD OF PROCESSING HYBRID SERVICE AND HYBRID DIGITAL CABLE RECEIVING APPARATUS

(75) Inventors: Keum-yong OH, Yongin-si (KR); Young-min Park, Seongnam-si (KR); Sung-jin Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/127,256

(22) Filed: May 27, 2008

(30) Foreign Application Priority Data
Jul. 6, 2007 (KR) 10-2007-0068191

(51) Int. Cl. H04N 7/173

(52) U.S. Cl. 725/109; 725/131

(57) ABSTRACT

A method of processing a hybrid service and a hybrid digital cable receiving apparatus are provided. The hybrid digital cable receiving apparatus includes a transmitting/receiving unit for receiving a hybrid signal, an Internet protocol television (IPTV) service processing unit for processing data corresponding to an IPTV service that is included in the received hybrid signal, and a cable service processing unit for processing data corresponding to a cable broadcasting service that is included in the received hybrid signal.

### CROSS REFERENCE TO RELATED APPLICATION

This application claims priority from Korean Patent Application No. 10-2007-0068191 filed on Jul. 6, 2007, in the Korean Intellectual Property Office, the disclosure of which is incorporated herein by reference in its entirety.

### BACKGROUND OF THE INVENTION

1. Field of the Invention

Methods and apparatuses consistent with the present invention relate to a hybrid service, and more particularly, to processing a hybrid service including an IPTV service and a cable broadcasting service.

2. Description of the Related Art

With the development of broadcasting technologies, digital broadcasting using satellites, terrestrial waves, and cables has become widely available. In order to receive digital broadcasting that is provided by a broadcasting provider, a user uses a broadcasting receiving apparatus, such as a set-top box or a digital television (TV). In the digital broadcasting, video data and audio data are compressed as digital information, and output to the broadcasting receiving apparatus. The broadcasting receiving apparatus decompresses the compressed video and audio data, and provides the original video and audio data to the user. In recent years, a demand has increased on an Internet protocol TV (IPTV) service that applies an IP-based broadcasting service.

The digital broadcasting service or the IPTV service can further satisfy a user, as compared with a previous service environment. However, since the user compositely uses a variety of services, a technology that is capable of satisfying various demands from the user is needed.

### SUMMARY OF THE INVENTION

The present invention provides a method and apparatus for processing a hybrid signal in which an IPTV service and a cable broadcasting service are integrated.

Aspects of the present invention are not limited to foregoing, and other aspects of the present invention will be apparently understood by those skilled in the art through the following description.

According to one aspect of the invention, there is provided a hybrid digital cable receiving apparatus, the apparatus including a transmitting/receiving unit receiving a hybrid signal, an IPTV service processing unit for processing data relevant to an IPTV service that is included in the received hybrid signal, and a cable service processing unit processing data relevant to a cable broadcasting service that is included in the received hybrid signal.

According to another aspect of the invention, there is provided a method of processing a hybrid service, the method including receiving a hybrid signal, extracting first data relevant to an IPTV service and second data relevant to a cable broadcasting service from the received hybrid signal, and providing a program guide that allows a user to use a guide service, by using first and second data.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram illustrating a hybrid service system according to an exemplary embodiment of the invention;

FIG. 2 is a block diagram illustrating a hybrid digital cable receiving apparatus according to an exemplary embodiment of the invention;

FIG. 3 is a diagram illustrating a middleware architecture according to an exemplary embodiment of the invention;

FIG. 4 is a block diagram illustrating a hybrid service processing unit according to an exemplary embodiment of the invention;

FIG. 5 is a diagram illustrating a course of processing a hybrid service according to an exemplary embodiment of the invention;

FIG. 6 is a diagram illustrating a user interface according to an exemplary embodiment of the invention; and

FIG. 7 is a diagram illustrating a user interface according to another exemplary embodiment of the invention.

### DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention will only be defined by the appended claims. Like identification codes refer to like elements throughout the specification.

The present invention will be described hereinafter with reference to block diagrams or flowchart illustrations of an apparatus and method of processing data of a non-volatile memory according to an exemplary embodiment thereof. It is to be understood that blocks in the accompanying block diagrams and compositions of steps in flow charts can be performed by computer program instructions. These computer program instructions can be loaded onto processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the steps in the flow charts. Further, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flow charts.

Each block or each step may indicate a portion of a module, a segment or a code including one or more executable instructions for performing a specific logical function (or functions). It should be noted that, in some modifications of the present invention, the functions described in the blocks or the steps may be generated out of order. For example, two blocks or steps continuously shown can be actually performed at the same time, or they can sometimes be performed in reverse order according to the corresponding functions.

The present invention will now be described more fully with reference to the accompanying drawings, in which exemplary embodiments of the present invention are shown.

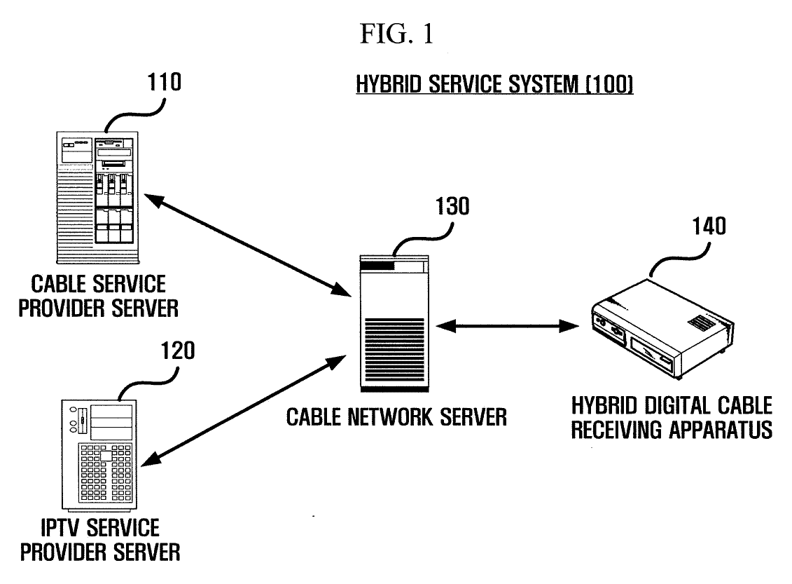

FIG. 1 is a diagram illustrating a hybrid service system 100 according to an exemplary embodiment of the present invention. The hybrid service system 100 includes a cable service provider server 110, an IPTV service provider server 120, a cable network server 130, and a hybrid digital cable receiving apparatus 140.

The cable service provider server 110 can provide a cable broadcasting service, such as a digital cable TV program. In this case, the digital cable TV program may include multimedia data. Preferably, but not necessarily, the digital cable TV program may be an Open Cable Application Platform (OCAP)-based broadcasting program that includes an OCAP application. The OCAP is an application platform that includes all Java application program interfaces covering numerous functionalities of cable services, media contents and data formats, and protocols for applications.

The IPTV service provider server 120 can provide an IPTV service that includes multimedia data. For example, the IPTV service may include a Pay Per View (PPV), a Video On Demand (VOD), and other on-demand contents.

The cable network server 130 transmits hybrid signals, which include services provided by the cable service provider server 110 and the IPTV service provider server 120, to the digital cable receiving apparatus 140. In this exemplary embodiment, the cable network server 130 can transmit a cable broadcasting stream and IPTV data by using a cable broadcasting channel and an IPTV channel, respectively, that are set in advance. An in-band channel may be an example of the cable broadcasting channel, and a Data over Cable Service Interface Specification (DOCSIS) channel may be an example of the IPTV channel.

The hybrid digital cable receiving apparatus 140 can be connected to the cable network server 130 through an IP converged cable. The IP converged cable is a transmission medium that can simultaneously transmit the cable broadcasting stream and the IPTV data, for example, an Hybrid Fiber Coax (HFC).

The hybrid digital cable receiving apparatus 140 can process both the cable broadcasting stream and the IPTV data that are provided by the cable network server 130. Preferably, but not necessarily, the hybrid digital cable receiving apparatus 140 extracts a service (cable broadcasting service or IPTV service), which is selected by a user, from a hybrid signal transmitted by the cable network server 130, performs a necessary process, and provides the service to the user. The hybrid digital cable receiving apparatus 140 will now be described in detail.

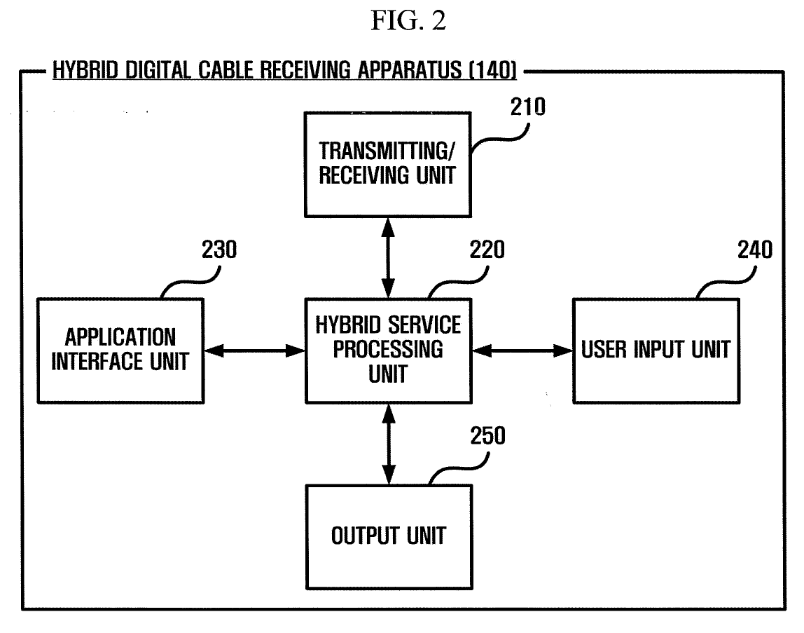

FIG. 2 is a block diagram illustrating a hybrid digital cable receiving apparatus 140 according to an exemplary embodiment of the present invention. The hybrid digital cable receiving apparatus 140 includes a transmitting/receiving unit 210, a hybrid service processing unit 220, an application interface unit 230, a user input unit 240, and an output unit 250.

The transmitting/receiving unit 210 can communicate with the cable network server 130. The transmitting/receiving unit 210 may include a cable broadcasting interface unit (not shown) that is in charge of communication using the cable broadcasting channel and an IPTV interface unit (not shown) that is in charge of communication using the IPTV channel. In this exemplary embodiment, the cable broadcasting interface unit may include a slot through which a cable card is connected, and the IPTV interface unit may include a DOCSIS interface unit.

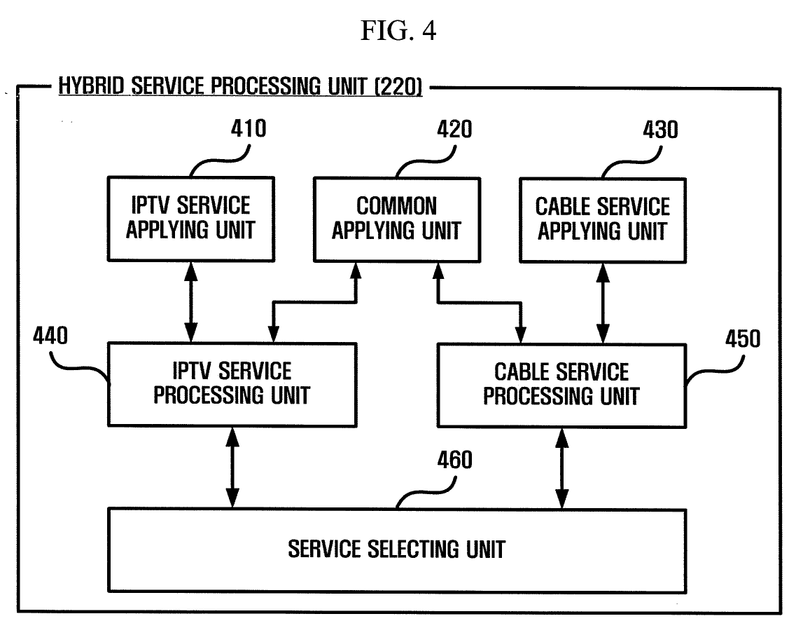

The hybrid service processing unit 220 can process the cable broadcasting stream and the IPTV data that are transmitted through the transmitting/receiving unit 210. Further, the hybrid service processing unit 220 generates a request message that is to be transmitted to the cable service provider server 110 or the IPTV service provider server 120 in accordance with a request from the user or an application, and transmits the generated request message to the transmitting/receiving unit 210. The detailed description of the hybrid service processing unit 220 will be described below with reference to FIG. 4.

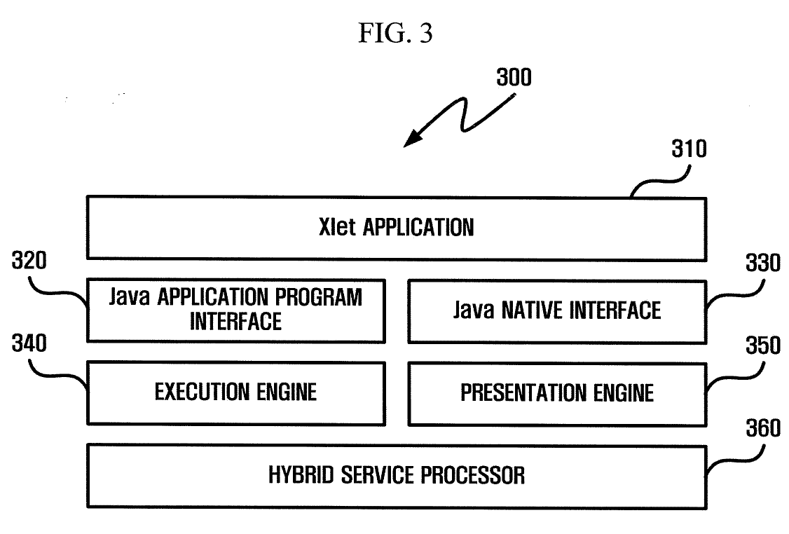

The application interface unit 230 transmits a request from an application, which supports the cable broadcasting service or the IPTV service, to the hybrid service processing unit 220. Further, the application interface unit 230 can transmit the process result of the hybrid service processing unit 220 according to the request to the application. Preferably, but not necessarily, the application may be an OCAP-based Xlet application. When the Xlet application is used, the hybrid digital cable receiving apparatus 140 may be based on a middleware architecture 300, as shown in FIG. 3.

The Xlet application 310 can communicate with an execution engine 340 by using a Java application program interface (Java API) 320 and a Java native interface (JNI) 330.

The presentation engine 350 can execute declarative applications, such as Extensible Hyper Text Markup Language (XHTML) or Scalable Vector Graphics (SVG). Further, the presentation engine 350 helps the Xlet application 310 to present contents with a browser. The execution engine 340 and the presentation engine 350 may be independent of a network interface through which input services are transmitted.

A hybrid service processor 360 can process service data and monitor interfaces. Specifically, the hybrid service processor 360 can process a cable broadcasting stream and IPTV data that are transmitted through the cable broadcasting channel and the IPTV service channel.

The Java API 320 and the JNI 330, which are shown in FIG. 3, can be implemented by the application interface unit 230, which is shown in FIG. 2. The hybrid service processor 360, which is shown in FIG. 3, can be implemented by the hybrid service processing unit 220, which is shown in FIG. 2. Meanwhile, although not shown in FIG. 2, the hybrid digital cable receiving apparatus 140 may further include an application processing unit that executes the Xlet application 310 shown in FIG. 3, and an engine driving unit that drives the execution engine 340 and the presentation engine 350 shown in FIG. 3.

Referring to FIG. 2 again, the user input unit 240 can receive a request from the user and transmit the input request to the hybrid service processing unit 220. The user input unit 240 may include an input device, such as a button, a keypad, a touch pad, a touch screen, and the like.

The output unit 250 can output information, which is processed by the hybrid service processing unit 220, to a display device (not shown) and a speaker (not shown). The information, which has been processed by the hybrid service processing unit 220, may include video data, audio data, graphic data, text data, and the like.

FIG. 4 is a block diagram illustrating a hybrid service processing unit 220 according to an exemplary embodiment of the present invention. The hybrid service processing unit 220 includes an IPTV service applying unit 410, a common applying unit 420, a cable service applying unit 430, an IPTV service processing unit 440, a cable service processing unit 450, and a service selecting unit 460.

The service selecting unit 460 determines a type of service that is transmitted by the transmitting/receiving unit 210, and requests the IPTV service processing unit 440 or the cable service processing unit 450 to process the service, in accordance with the service type.

The cable service processing unit 450 can process data that is input through the cable broadcasting channel, and compose information on the cable broadcasting service. Further, the IPTV service processing unit 440 can process data input through the IPTV channel, and compose information on the IPTV service.

The IPTV service applying unit 410 can construct data, which has been processed by the IPTV service processing unit 440, according to a standard of the IPTV service. For example, the IPTV service applying unit 410 can provide a user interface in a form of IPTV service defined in advance, by using the information on the IPTV service that is composed by the IPTV service processing unit 440.

Similarly, the cable service applying unit 430 can construct data, which has been processed by the cable service processing unit 450, according to a standard of the cable broadcasting service. Further, the common applying unit 420 can combine information that can be commonly processed in the IPTV service and the cable broadcasting service, and process the information.

Some examples of information that can be processed by the common applying unit 420 are system and service information (SI) and conditional access information (CAI). The SI can include various section tables. Specifically, the SI can include a master guide table (MGT) that maps several tables and the program identifier (PID), a network information table (NIT) that informs the channel features such as a frequency, a short-form virtual channel table (SVCT) that informs information such as a channel number, and a long-form channel table (LVCT).

Further, the information that can be processed by the common applying unit 420 is not limited to the above examples, and the common applying unit 420 can process various sets of additional information on a cable broadcasting stream. For example, if a Moving Picture Experts Group-2 (MPEG-2) standard is used in both the IPTV service and the cable broadcasting service in order to generate the cable broadcasting stream, the common applying unit 420 can process additional information on the MPEG-2 stream, and the additional information can be defined by the society of cable television engineers (SCTE) standard. The additional information may be defined as a different type such as an advanced television systems committee (ATSC) standard or a digital video broadcasting (DVB) standard.

Further, the common applying unit 420 can analyze video/audio data, analyze additional data of video/audio data, encrypt and decrypt the video/audio data, analyze program guide information, and analyze security information.

The IPTV service applying unit 410 and the cable service applying unit 430 can be integrated with the IPTV service processing unit 440 and the cable service processing unit 450, respectively.

Meanwhile, the components, which constitute the hybrid digital cable receiving apparatus 140 having been described with reference to FIGS. 2 and 4, may be implemented by modules. The term “module” means a hardware component such as a Field Programmable Gate Array (FPGA) or an Application Specific Integrated Circuit (ASIC) and the modules each perform assigned functions. However, the modules are not limited to software or hardware. The modules may be configured in an addressable storage medium, or may be configured to run on at least one processor. Therefore, as an example, the modules include: components such as software components, object-oriented software components, class components, and task components; processors, functions, attributes, procedures, sub-routines, segments of program codes, drivers, firmware, microcodes, circuits, data, databases, data structures, tables, arrays, and variables. The functions provided by the components and the modules may be combined into fewer components and/or modules may be separated into additional components and modules.

If a part or all of the components are implemented by software, the digital cable receiving apparatus 140 may further include a CPU that drives the software, and a memory that stores a state of the software and an execution state of the software.

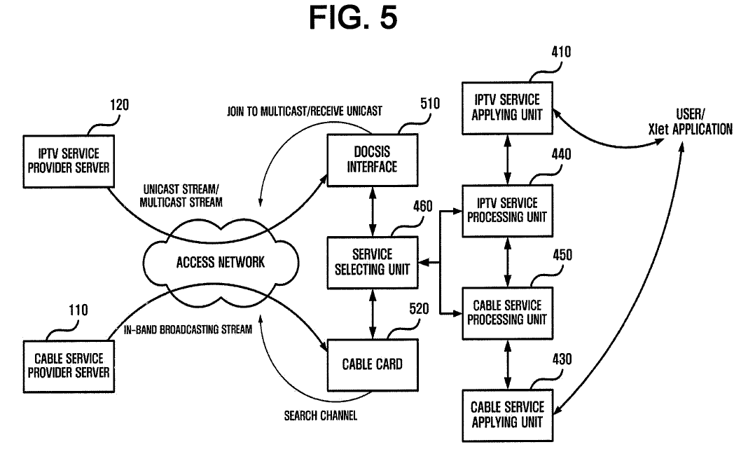

FIG. 5 is a diagram illustrating a course of processing a hybrid service according to an exemplary embodiment of the present invention. In FIG. 5, a cable card 520 is used to access a cable broadcasting channel and a DOCSIS interface 510 is used to access the IPTV channel. However, the present invention is not limited thereto.

The course of processing a hybrid service may include a course of providing a program guide (user interface) that allows a user to use the guide service, and a course of providing a specific service (cable broadcasting service or IPTV service) according to the request from the user.

First, the course of providing a program guide will be described in detail.

The service selecting unit 460 transmits information on the cable broadcasting service, which is transmitted through the cable card 520 of the transmitting/receiving unit 210, to the cable service processing unit 450. The cable broadcasting service information can be transmitted through an out-of-band channel.

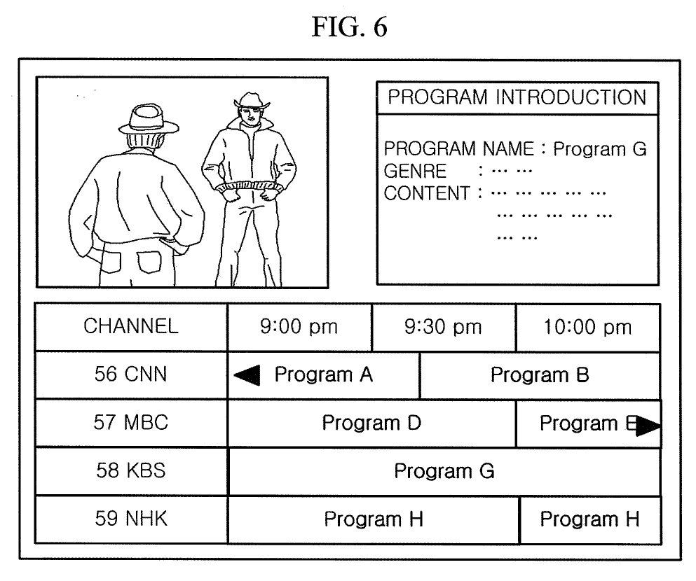

The cable service processing unit 450 can parse cable broadcasting supplementary information, and compose the parsed cable broadcasting supplementary information with service information, such as logical channel data, a called channel map, relevant additional data, and the like. The cable service applying unit 430 can provide a user interface that guides a searching operation on the cable broadcasting channel on the basis of the service information. An example of the user interface, which is provided by the cable service applying unit 430, is shown in FIG. 6. The user interface, which is shown in FIG. 6, is only exemplary, and the present invention is not limited thereto.

Meanwhile, similar to the above-described method, the IPTV service data can be processed. Specifically, the service selecting unit 460 can transmit an IP packet, which is transmitted through the DOCSIS interface 510, to the IPTV serving processing unit 440. In a payload of the IP packet, IPTV service information, such as a channel list, may be included in a format of meta data, such as Extensible Markup Language (XML). The IPTV service processing unit 440 extracts the IPTV service information that is included in the payload of the IP packet, and generates a list of services, which can be used by the user, on the basis of the extracted IPTV service information.

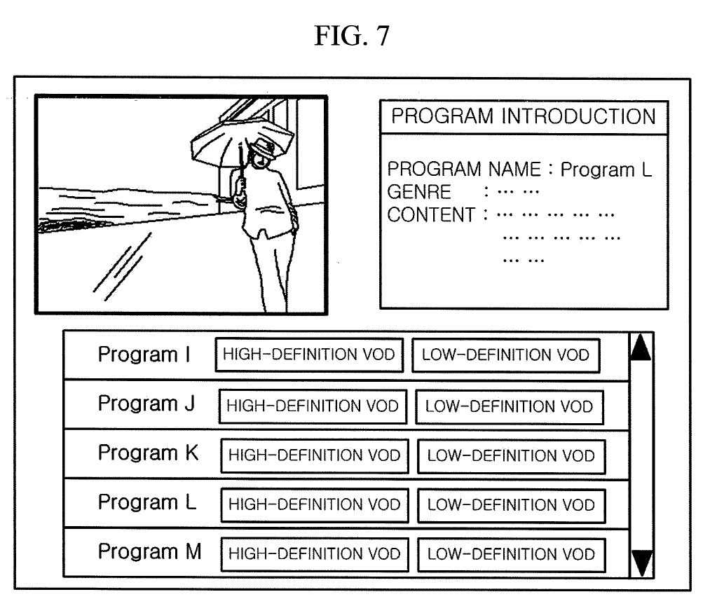

In this exemplary embodiment, the IPTV service processing unit 440 may include a filter (not shown) and a parser (not shown). The filter can extract the payload data of the IP packet, and the parser can convert the extracted payload data into a list of services list that includes usable services. The IPTV service applying unit 410 can provide a user interface that guides a service searching operation using the list of services that is provided by the IPTV service processing unit 440. An example of the user interface, which is provided by the IPTV service applying unit 410, is shown in FIG. 7. The user interface, which is shown in FIG. 7, is exemplary, and the present invention is not limited thereto.

By using the series of processes that are described above, a program guide (which may include user interfaces shown in FIGS. 6 and 7), which may be used to search a channel or service, and select a VOD or PPV, and for query data of the Xlet application, may be provided. The program guide may be transmitted to a display device through the output unit 250, and the display device can display the program guide.

The course of providing a program guide, which has been described, may be performed when the user makes a request. For example, when the user requests cable broadcasting service information, a course of providing a program guide may be performed through the cable card 520, the service selecting unit 460, the cable service processing unit 450, and the cable service applying unit 430. Further, when the user requests IPTV service information, a course of providing a program guide may be performed through the DOCSIS interface 510, the service selecting unit 460, the IPTV service processing unit 440, and the IPTV service applying unit 410.

Though not illustrated in FIG. 5, as described above, the common information can be processed by the common applying unit 420 in the IPTV service and the cable broadcasting service. That is, the IPTV service processing unit 440 and the cable service processing unit 450 can send a request that the common applying unit 420 process the information that can be commonly processed in the IPTV service and the cable broadcasting service, and can be provided a result of the processing by the common applying unit 420. The type of the information to be processed by the common applying unit 420 may have been set in advance.

The IPTV service information may be transmitted in a multicast stream. When the user requests the IPTV service information, the IPTV service processing unit 440 can perform a control operation such that the multicast stream is received through the DOCSIS interface 510. For example, the IPTV service processing unit 440 generates an IPTV service information request message, and transmits the IPTV service information request message to the IPTV service provider server 120 through the DOCSIS interface 510. When the IPTV service information request message is transmitted from the hybrid digital cable receiving apparatus 140, the IPTV service provider server 120 may add the hybrid digital cable receiving apparatus 140 as a receiving subject of the multicast stream. As a result, the multicast stream may be transmitted to the hybrid digital cable receiving apparatus 140.

In this exemplary embodiment, the hybrid digital cable receiving apparatus 140 periodically constructs a program guide. When the user requests the program guide, the hybrid digital cable receiving apparatus 140 can provide the program guide that has been constructed in advance.

Further, when the user requests to transmit the hybrid service information, the IPTV service information and the cable broadcasting service information can be simultaneously provided to the user.

If the program guide is provided for the user, the user can search and select a desired service through the program guide. If the user presses a channel button on a remote controller, the service selection from the user can be transmitted to the cable card 520 through the cable service applying unit 430, the cable service processing unit 450, and the service selecting unit 460. The cable card 520 searches the in-band channel that corresponds to the service selection from the user, and transmits an in-band broadcasting stream, which is transmitted through the searched channel, to the service selecting unit 460. The service selecting unit 460 can transmit the in-band broadcasting stream to the cable service processing unit 450.

The cable service processing unit 450 processes the in-band broadcasting stream (for example, demultiplexing and decoding processes), and transmits cable broadcasting data included in the in-band broadcasting stream to the output unit 250 through the cable service applying unit 430. Therefore, the user can view broadcasting of the channel which is selected by the user.

Meanwhile, if the user requests to transmit a specific VOD of the IPTV service, the service request from the user can be transmitted to the IPTV service processing unit 440 through the IPTV service applying unit 410. The IPTV service processing unit 440 can generate a VOD service request message that includes information on the requested VOD. The generated VOD service request message can be transmitted to the IPTV service provider server 120 through the service selecting unit 460 and the DOCSIS interface 510.

The IPTV service provider server 120 can transmit the requested VOD service in a unicast stream. The unicast stream can be transmitted to the IPTV service processing unit 440 through the DOCSIS interface 510 and the service selecting unit 460. The IPTV service processing unit 440 can extract and decode the VOD data that is included in the unicast stream. The decoded multimedia data can be transmitted to the output unit 250 through the IPTV service applying unit 410. The output unit 250 can output the multimedia data through the display device and the speaker. Therefore, the user can view the VOD contents that are selected by the user. The VOD is only one example, and a different type of IPTV service including multimedia data may be exemplified in this present invention.

In this exemplary embodiment, the hybrid digital cable receiving apparatus 140 may further include a decoding unit that decodes video data, audio data, graphic data, text data, and the like. In this case, the decoding unit can decode broadcasting data in the in-band broadcasting stream that is transmitted by the cable service proving server 110 or VOD data (video data or audio data) in the unicast stream that is transmitted by the IPTV service provider server 120.

In this exemplary embodiment, the hybrid service processing unit 220 may further include a determining unit that determines a type of request from the user or Xlet application. The determining unit determines whether the input request is a request for the IPTV service or a request for the cable broadcasting. In accordance with the determination result, the determining unit can transmit the request from the user or Xlet application to the IPTV service applying unit 410 or the cable service applying unit 430.

Although the present invention has been described in connection with the exemplary embodiments, it will be apparent to those skilled in the art that various modifications and changes may be made thereto without departing from the scope and spirit of the invention. Therefore, it should be understood that the above exemplary embodiments are not limitative, but illustrative in all aspects.

According to the method of processing a hybrid service and the hybrid digital cable receiving apparatus according to the exemplary embodiment of the present invention, it is possible to provide a variety of services to the user in a simplified method.

What is claimed is:

1. A hybrid digital cable receiving apparatus, the apparatus comprising:
a transmitting/receiving unit that receives a hybrid signal;
an IPTV service processing unit that processes first data corresponding to an Internet Protocol television (IPTV) service that is included in the received hybrid signal; and
a cable service processing unit that processes second data corresponding to a cable broadcasting service that is included in the received hybrid signal.

2. The apparatus of claim 1, further comprising a service selecting unit that requests the IPTV service processing unit and the cable service processing unit to perform a service process, in accordance with a type of data that is included in the hybrid signal.

3. The apparatus of claim 1, further comprising:
an IPTV service applying unit that constructs the processed first data according to a standard of the IPTV service; and
a cable service applying unit that constructs the processed second data according to a standard of the cable broadcasting service.

4. The apparatus of claim 3, wherein at least one of the IPTV service applying unit and the cable service unit periodically constructs at least one of the first data and the second data according to at least one of the standard of the IPTV service and the standard of the cable broadcasting service, respectively, and provides a user or an application with at least one of the constructed first data and second data, and
wherein the provided at least one of first data and second data is data that has been constructed before the user or the application requests at least one of the constructed first and second data.

5. The apparatus of claim 3, wherein the IPTV service applying unit and the cable service applying unit provides a user or an application with the constructed first data and the processed second data substantially at the same time.

6. The apparatus of claim 3, wherein the IPTV service applying unit provides a user interface that includes information on the IPTV service, and
wherein the cable service applying unit provides a user interface that includes information on the cable broadcasting service.

7. The apparatus of claim 3, further comprising a determining unit that transmits a request from a user to the IP service applying unit or the cable service applying unit according to a type of the request from the user.

8. The apparatus of claim 1, wherein the transmitting/receiving unit comprises:
an IPTV interface unit that performs communication in a channel through which the IPTV service is transmitted; and
a cable broadcasting interface unit that performs communication in a channel through which the cable broadcasting service is transmitted.

9. The apparatus of claim 8, wherein the IPTV interface unit comprises a Data over Cable Service Interface Specification (DOCSIS) interface unit, and
wherein the cable broadcasting interface unit comprises a cable card.

10. The apparatus of claim 1, wherein the IPTV service comprises an Open Cable Application Platform (OCAP)-based broadcasting program.

11. The apparatus of claim 1, wherein the cable broadcasting service comprises on-demand contents

12. The apparatus of claim 1, further comprising at least one of an application interface unit and a user input unit,
wherein the application interface unit receives a request from an application that supports at least one of the cable broadcasting service and the IPTV service, and transmits the request from the application to at least one of the IPTV service processing unit and the cable broadcasting service unit according to a type of the request from the application, and
wherein the user input unit receives and transmits a user request to at least one of the IPTV service processing unit and the cable broadcasting service unit according to a type of the user request.

13. The apparatus of claim 12, wherein the application comprises an Open Cable Application Platform (OCAP)-based application.

14. The apparatus of claim 13, wherein the OCAP-based application comprises a Java application.

15. The apparatus of claim 13, wherein the OCAP-based application comprises an Xlet application.

16. The apparatus of claim 1, further comprising a common applying unit that processes common information that is commonly processed in the IPTV service and the cable broadcasting service.

17. The apparatus of claim 16, wherein the common information includes at least one of video/audio data, additional data of the video/audio data, encoding/decoding information on the video/audio data, broadcasting stream additional information, channel information, program guide information, and security information.

18. A method of processing a hybrid service, the method comprising:
receiving a hybrid signal;
extracting at least one of first data corresponding to an Internet Protocol television (IPTV) service and second data corresponding to a cable broadcasting service from the received hybrid signal; and
providing at least one of first service corresponding to the extracted first data and second service corresponding to the extracted second data.

19. The method of claim 18, wherein the at least one of first service and second service comprises a program guide.

20. The method of claim 18, wherein the extracting at least one of first data and second data comprises extracting IPTV service information from the first data, and
wherein the providing at least one of first service and second service comprises providing a first user interface.

21. The method of claim 18, wherein the extracting at least one of first data and second data comprises extracting cable broadcasting service information from the second data, and
wherein the providing at least one of first service and second service comprises providing a second user interface.

22. The method of claim 18, wherein the at least one of first data and second data is periodically extracted, and
wherein the at least one of first service and second service corresponds to the extracted at least one of first data and second data, respectively, which has been extracted before a user or an application requests the at least one of first service and second service.

23. The method of claim 18, wherein the first service and the second service are provided substantially at the same time.

24. The method of claim 18, further comprising receiving a request from a user or an application that requests the at least one of first service and second service,
wherein, according to a type of the request, at least one of first service and second service to be provided is determined.

25. The method of claim 24, wherein the providing of the at least one of first service and second service comprises:
receiving, if the type of the request is the IPTV service, a unicast stream transmitted by an IPTV service provider server; and
outputting multimedia data that is included in the unicast stream.

26. The method of claim 24, wherein the providing of the at least one of first service and second service comprises:
receiving, if the type of the request is the cable broadcasting service, an in-band broadcasting stream; and
outputting cable broadcasting data that is included in the in-band broadcasting stream.

27. The method of claim 18, wherein the at least one of first service and second service is provided to an application which comprises an Open Cable Application Platform (OCAP)-based Xlet application.

28. The method of claim 19, wherein the providing of the program guide includes integrating and processing common information commonly provided from the IPTV service and the cable broadcasting service.

29. The method of claim 28, wherein the common information includes at least one of video/audio data, additional data of the video/audio data, encoding/decoding information on the video/audio data, broadcasting stream additional information, channel information, program guide information, and security information.
